(19) United States
(12) Patent Application Publication
(10) Pub. No.: US 2007/0068325 A1
(43) Pub. Date: Mar. 29, 2007

(54) Shift mechanism for a vehicle

(76) Inventors: Joseph E. Rudelic, Canton, MI (US); William E. Dutka II, Novi, MI (US); Christopher Eanes, Canton, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/220,257

(22) Filed: Sep. 6, 2005

(51) Int. Cl. G05G 1/04

(52) U.S. Cl. 74/523

(57) ABSTRACT

A shift mechanism for a vehicle has a lever portion movable between two or more shift states, an engagement mechanism that selectively allows the lever portion to move between the shift states, and a rotatable knob that cooperates with the engagement mechanism such that the engagement mechanism allows the lever portion to move between the shift states when the rotatable knob is rotated in at least a first rotational direction.

### FIELD OF THE INVENTION

The present invention relates to a shift mechanism for a motor vehicle, and more particularly to a gear selection apparatus of a shift mechanism for a motor vehicle.

### BACKGROUND

A vehicle shift mechanism is used to select amongst various gears of a vehicle transmission. Such a shift mechanism typically utilizes a movable shift lever that interacts with the gears of the transmission. For example, in an automatic transmission, a vehicle shift mechanism is used to shift the transmission between park, neutral, reverse, and drive among other possible shift states.

In some shift mechanisms, the shift lever includes an actuating button that is pressed before the shift mechanism can be manipulated from one state to another. Such a button may be required to be pressed before a shift lever can be moved from park to drive. While such buttons help prevent accidental movement of the shift lever, drawbacks to using actuating buttons exist. In one example, the use of cumbersome gloves by the vehicle driver impedes the driver's ability to actuate such buttons. Also, the use of buttons necessitates additional expense for the assembly and manufacture of vehicles employing such button shift mechanisms. For example, left hand and right hand drives may require the buttons to be positioned on different sides of the shift lever, thereby requiring inventorying and installation of different shift levers depending on whether the shift mechanism is being used on a left-hand or right hand drive vehicle. Such inventorying and installation adds cost and complexity to the vehicle.

### SUMMARY OF THE INVENTION

A shift mechanism for a vehicle is provided having a lever portion movable between shift states, an engagement mechanism that selectively allows the lever portion to move between the shift states, and a rotatable knob that cooperates with the engagement mechanism such that the engagement mechanism allows the lever portion to move between the shift states when the rotatable knob is rotated in at least a first rotational direction.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a shift mechanism for a vehicle according to an embodiment of the invention;

FIG. 2 is an isometric view of a shift mechanism for a vehicle according to an embodiment of the invention;

FIG. 3 is an exploded isometric view of a shift mechanism for a vehicle according to an embodiment of the invention;

FIG. 4 is an isometric view of a knob of a shift mechanism for a vehicle according to an embodiment of the invention;

FIG. 5 is a top plan view of a body of a shift mechanism for a vehicle according to an embodiment of the invention;

FIG. 6 is a side view of a shift mechanism for a vehicle according to an embodiment of the invention;

FIG. 7 is a side view of a shift mechanism for a vehicle according to an embodiment of the invention;

FIG. 8 is a side view of a shift mechanism for a vehicle according to an embodiment of the invention; and

FIG. 9 is a side view of a shift mechanism for a vehicle according to an embodiment of the invention.

### DETAILED DESCRIPTION OF THE PREFERRED EMBODIMENTS

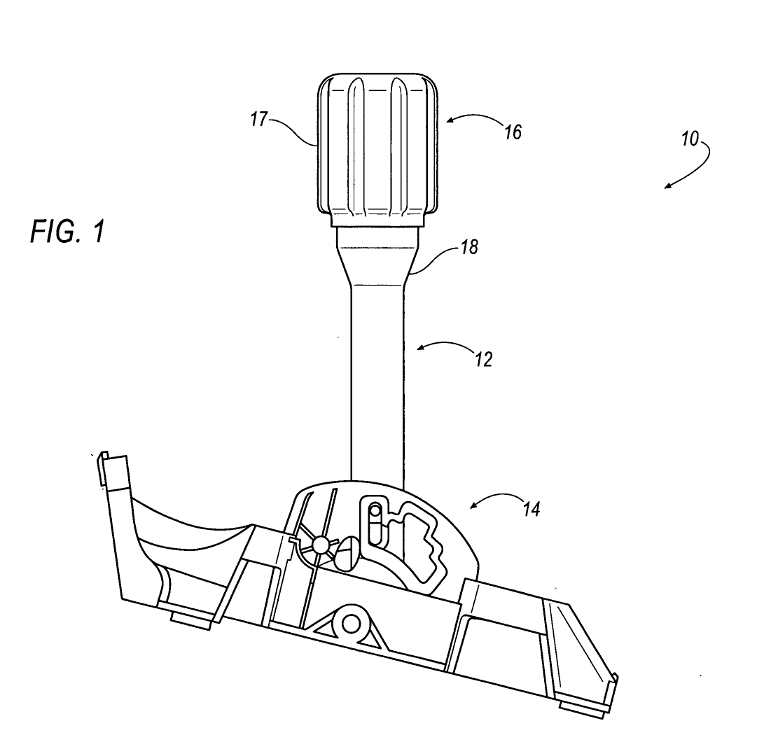

Referring now to FIG. 1, a shift mechanism 10 is shown and described according to a first exemplary embodiment of the invention. In FIG. 1, the shift mechanism 10 generally includes a lever portion 12 pivotally connected to a shifter gate 14. The lever portion 12 generally includes a lever body 18 and a rotatable knob 16 rotatably connected to the lever body 18. The rotatable knob 16, in an embodiment, includes surface 17 that has impressions or other configuration on its outer surface to increase frictional interaction between a user's hand and the rotatable knob 16. In an embodiment, the rotatable knob 16 selectively allows or disallows movement on the lever portion 12 through rotation of the rotatable knob 16. Rotation of the rotatable knob 16 cooperates with an engagement mechanism, one example of which is provided below, that selectively locks or unlocks the lever portion 12 to allow or disallow movement thereof.

In a first exemplary embodiment, the lever portion 12 is angularly movable about its pivotal connection to the shifter gate 14 for shifting between various shift states such as, for example, drive, park and reverse. It will be understood that the lever portion 12 may be used for a manual or automatic transmission, such as for shifting between gears 1, 2, etc, as well as other shifting devices.

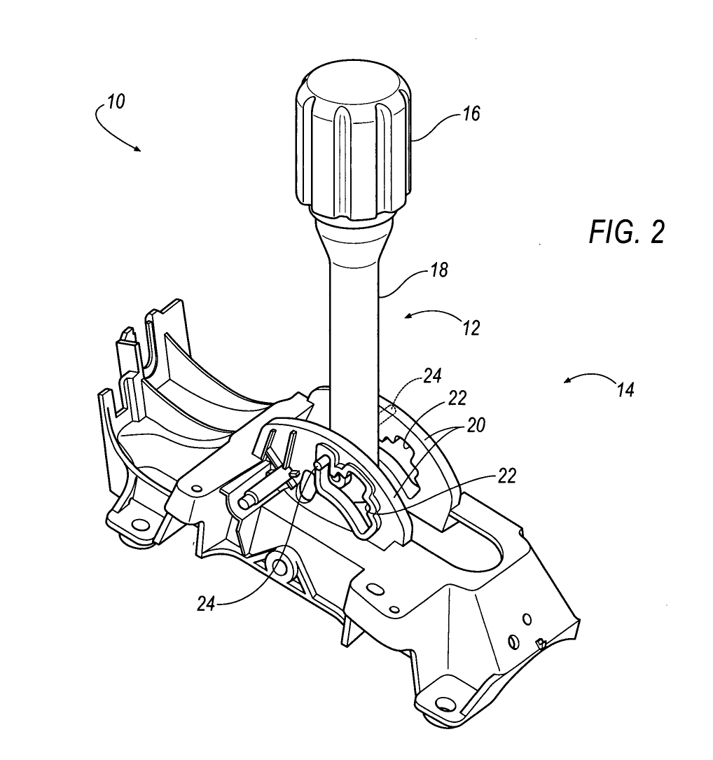

Now referring to FIG. 2, the shifter gate 14 is described in greater detail. The shifter gate 14 includes sides 20 disposed on radially opposite sides of the lever body 18. Sides 20 may have key formations 22 formed therein. Locking pin 24 extends from radially opposite sides of the lever body 18 for engagement and interaction with the key formations 22. As will be understood by one skilled in the art, key formations 22 include a series of steps and notches that interact with the locking pin 24 to selectively lock and unlock the lever portion 12 in or from a given shift state.

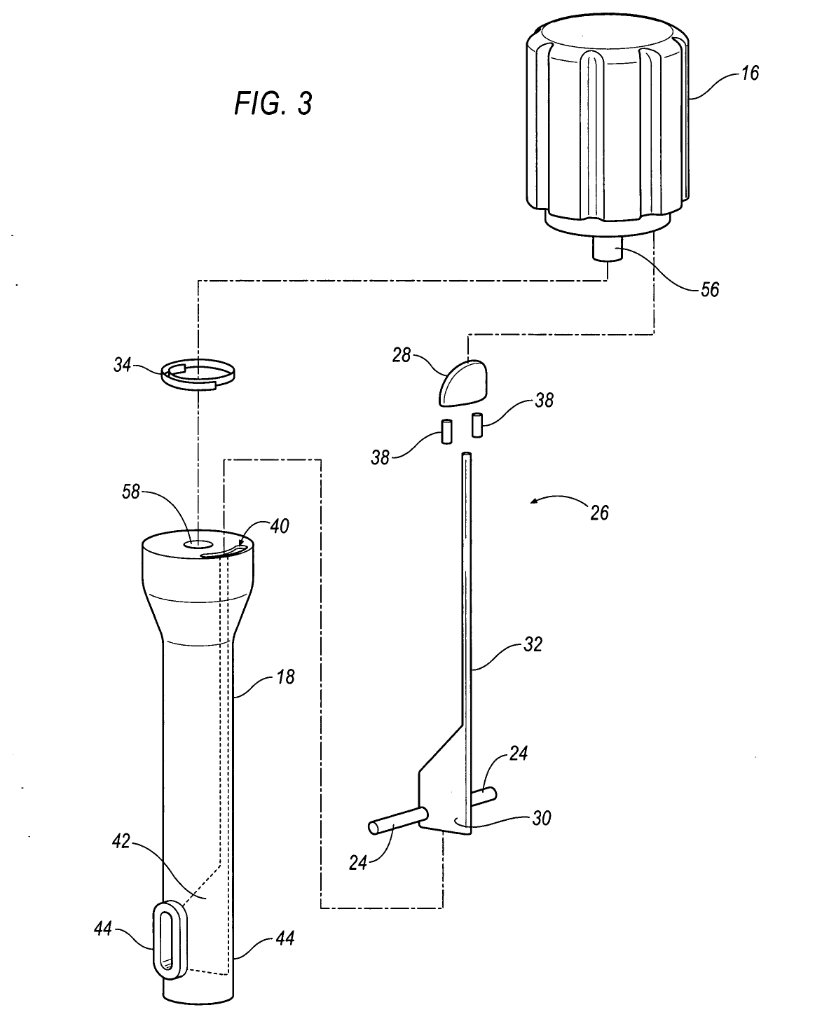

Referring now to FIG. 3, an exploded isometric view of the lever portion 12 having one example of an engagement mechanism is shown and described. The lever portion 12 includes the lever body 18, which is a generally cylindrical element having an aperture 58 at an upper region (with respect to a normal orientation of the shift mechanism 10) and locking pin apertures 44 formed as axially elongated holes on radially opposite sides of the lever body 18. As shown in FIGS. 2 and 5, an aperture 40 is also formed on a radially outward portion of the top surface of the lever body 18 for reasons that will be described in greater detail. Likewise, a guide aperture 42 extends through the lever body 18 to connect aperture 42 with locking pin apertures 44.

A rod assembly 26 generally includes a ramped element 28 positioned at an upper region (with respect to a normal orientation of the shift mechanism 10). Referring to FIGS. 2 and 5, the ramped element 28 resides in support region 52 of aperture 40 and is biased in an upward direction by return springs 38. The return springs 38 are positioned between the ramped element 28 and a bottom surface of the support region 52 to bias the ramped element 28 and attached rod assembly 26 in an upward direction with respect to the figure.

In an exemplary embodiment, the rod assembly 26 includes a guide portion 30 and a tubular portion 32. Locking pin 24 is supported by and radially extends from the guide portion 30. The guide portion 30 and tubular portion 32 reside within the guide aperture 42. The guide portion 30 can be sized relative to rod assembly to allow relatively unimpeded vertical movement of the rod assembly, while preventing the rod assembly 26 from rotating due to the non-symmetrical configuration of the guide portion. The tubular portion 32 transmits force from the ramped element 28 to the locking pin 24 as will be discussed. Of course, one skilled in the art will readily recognize other configurations that may be used for the rod assembly 26 while still accomplishing the above referenced function.

Return springs 38 act to bias the rod assembly 26 and the ramped element 28 in an upward direction with respect to the Figure for reasons that will be discussed.

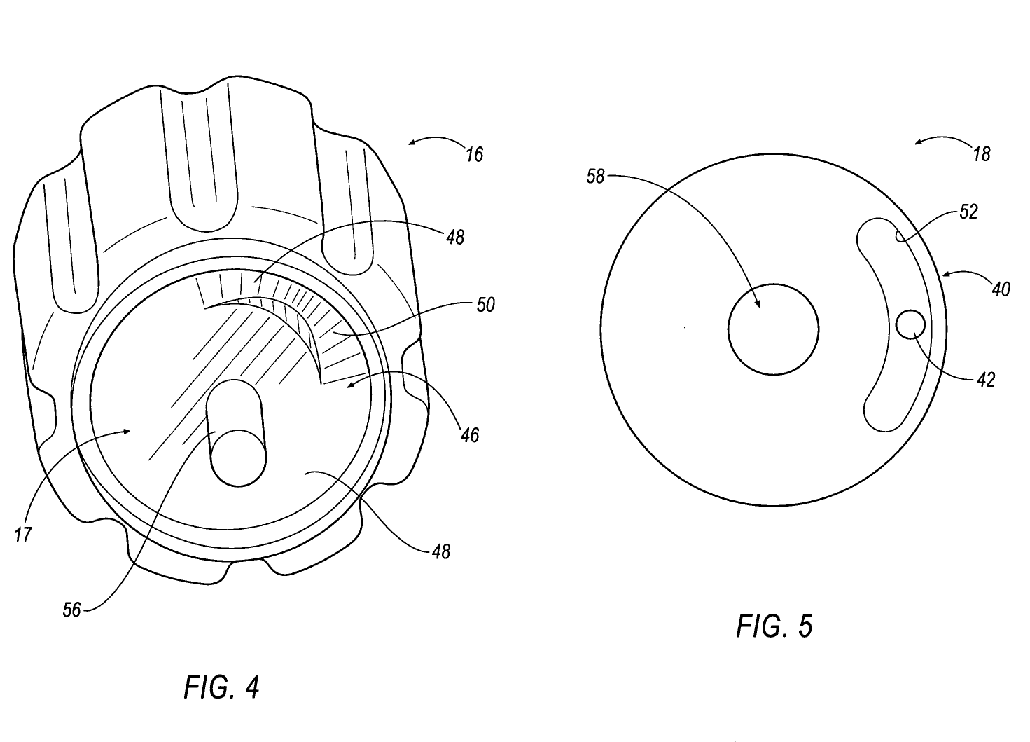

With continued reference to FIG. 3 and also referring to FIG. 4, rotatable knob 16 is described in greater detail. The rotatable knob 16 may include pivot 56 that cooperates with aperture 58. The engagement between pivot 56 and aperture 58 is loose enough to allow rotation of the rotatable knob 16 within aperture 58. A return spring 34 provides a spring bias that, as will be discussed, biases the rotatable knob 16 toward an initial position when the knob 16 is not influenced by a driver's hand. More specifically, in one embodiment, the rotatable knob 16 is rotatable against the biasing force of the return spring 34 during actuation. After actuation and upon release of the rotatable knob 16, the return spring 34 rotates the rotatable knob 16 back to the initial position about the pivot 56. Referring to FIG. 4, a bottom 17 portion (with respect to a normal orientation of the shift mechanism 10 as shown in FIG. 1) of the rotatable knob 16 includes a ramped portion 46 disposed at a radially outward portion of the rotatable knob 16. In an embodiment, the ramped portion 46 is located at a position that allows the ramped element 28 to engage the ramped portion 46.

The ramped portion 46 transitions from shallow regions 48 to a deep region 50. In an embodiment, the ramped element 28 resides within the deep region 50 when the rotatable knob 16 is in an unactuated position (for example, before the rotatable knob 16 is rotated by a user). When the rotatable knob 16 is rotated, the ramped portion 46 is rotated over the ramped element 28 to place the shallow region 48 over the ramped element 28 thereby moving the deeper region 50 away from the ramped element 28. In response, the shallow region 48 presses against the ramped element 28 to cause the ramped element 28 to move downward with respect to its orientation in FIG. 3. Likewise, release of the rotatable knob 16 allows the return spring 34 to urge the rotatable knob 16 in an opposite direction such that the deep region 50 is positioned over the ramped element 28 to allow the ramped element 28 to move upward with respect to its orientation in FIG. 3.

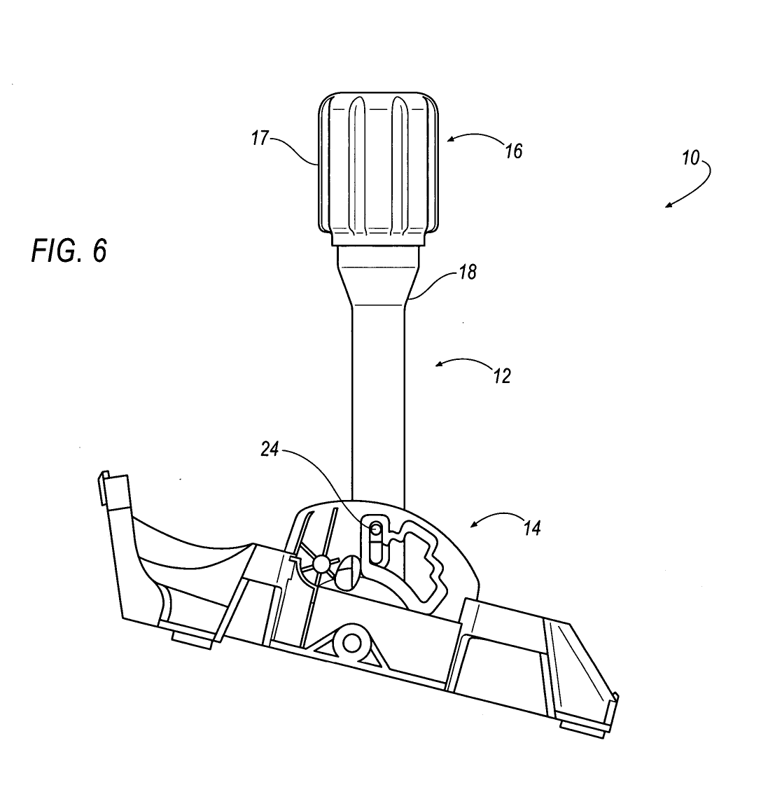

Referring now to FIGS. 6-8, the operation of an embodiment of the invention is shown and described. In FIG. 6, the shift mechanism 10 is shown in a locked or engaged state. Here, the shift mechanism may, for example, be in a parked position. In such a position, pushing or pulling on the lever portion 12 will not move the shift mechanism 10 to another state, such as drive, as the locking pin 24 interacts with the key formations 22 to prevent such movement.

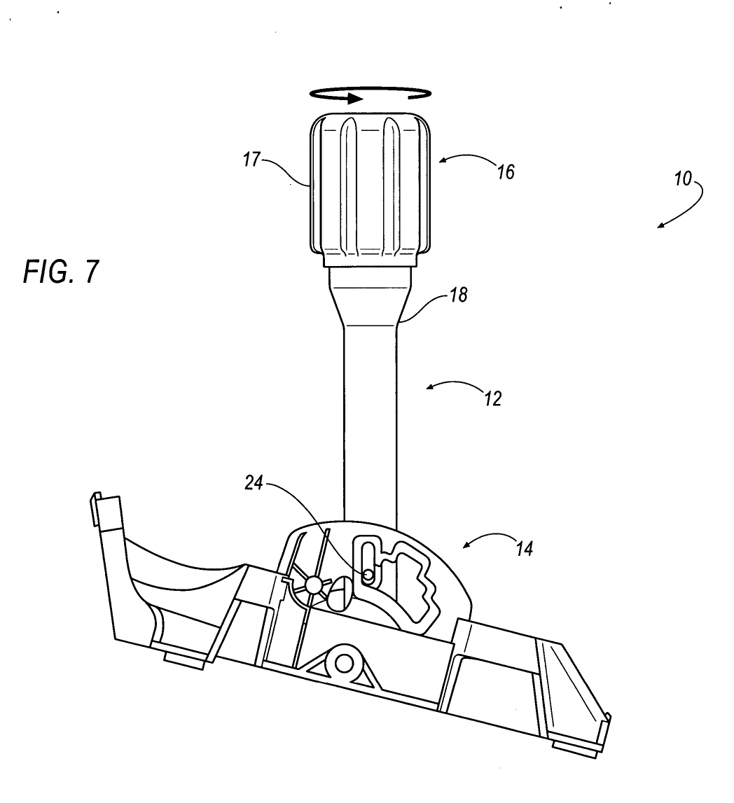

In FIG. 7, rotatable knob 16 is rotated in a direction that moves deep region 50 away from the ramped element 28 and moves one of the shallow regions 48 over the ramped element 28 (see FIG. 4). This movement drives the ramped element 28 downward with respect to the Figure and thereby drives rod assembly 26 downward as well. Such movement is against the biasing force of return springs 38. The movement of rod assembly 26 moves the locking pin 24 downward along locking pin apertures 44. As shown again in FIG. 7, this movement disengages the locking pin 24 from the key formations 22 (see FIG. 2) to allow the lever portion 12 to be angularly moved in the shifter gate 14, and thereby to be shifted between shift states.

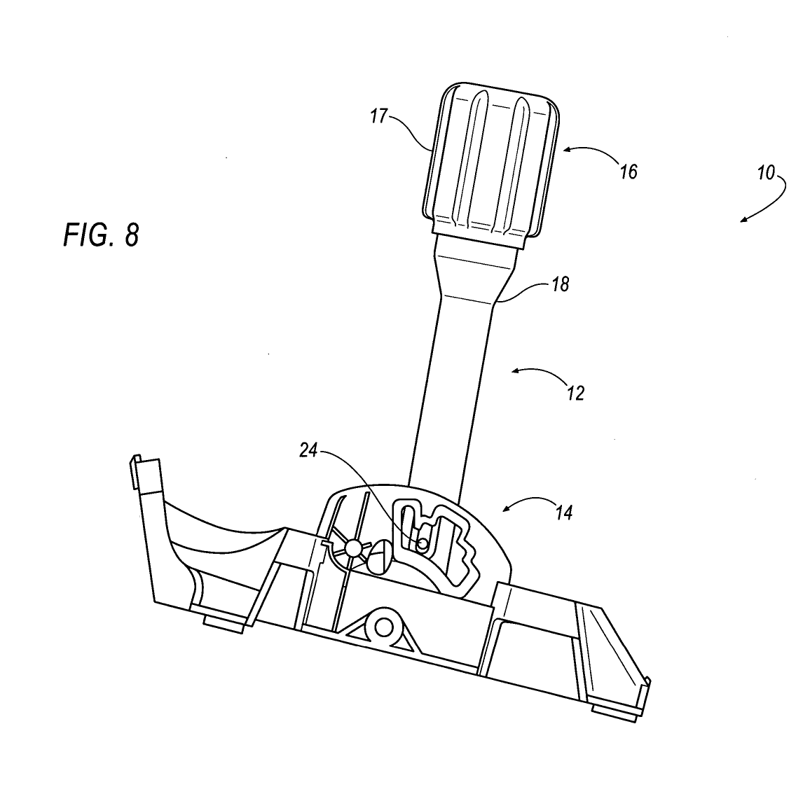

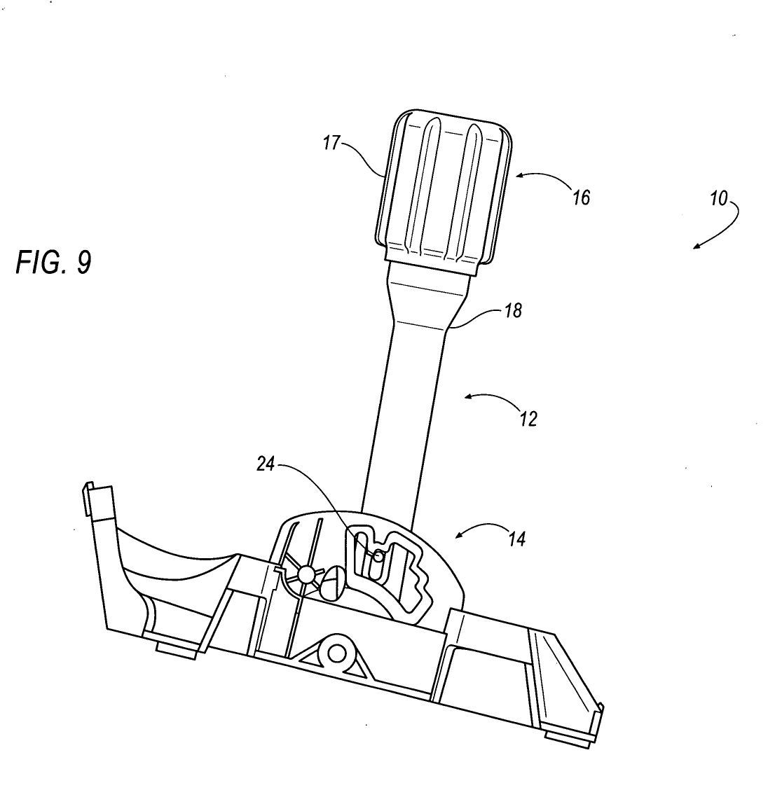

As shown in FIG. 8, once the desired shift state is obtained through movement of the lever portion 12, rotatable knob 16 is released. The biasing force of return spring 34 drives the rotatable knob 16 back to its initial position such that ramped element 28 is positioned under the deep region 50. This positioning allows the return springs 38 to push both the ramped element 28 and rod assembly 26 back to its initial upward position. As shown in FIG. 9, this movement causes locking pin 24 to move in an upward direction such that locking pin 24 engages key formations 22 to thereby lock the lever portion 12 in the desired shift state.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

1. A shift mechanism for a vehicle, comprising:
a shifter gate;
a lever portion movable between two or more shift states;
an engagement mechanism that selectively allows the lever portion to move between the two or more shift states, the engagement mechanism including a locking pin that cooperates with the shifter gate to selectively allow the lever portion to move between the two or more shift states; and
a rotatable knob that cooperates with the engagement mechanism such that the engagement mechanism allows the lever portion to move between the shift states when the rotatable knob is rotated in at least a first rotational direction.

2. The shift mechanism according to claim 1, wherein:
the lever portion includes a body portion; and
the engagement mechanism further includes a rod assembly that passes through the body portion.

3. The shift mechanism according to claim 2, wherein:
the engagement mechanism further includes a ramped element in cooperation with the rod assembly; and wherein
the rotatable knob includes a ramped surface that cooperates with the ramped element such that rotation of the rotatable knob presses the ramped element against the rod assembly to allow the lever portion to move between the two or more shift states.

4. The shift mechanism according to claim 2, wherein the locking pin extends from the rod assembly.

5. The shift mechanism according to claim 4, wherein the locking pin extends radially away from the rod assembly in opposite radial directions.

6. The shift mechanism according to claim 5, wherein the rod assembly further includes:
a guide portion proximate the locking pin; and
a tubular portion extending from the guide portion to a location proximate the ramped element.

7. (canceled)

8. The shift mechanism according to claim 3, further including at least one return spring that biases the ramped surface of the rotatable knob toward a locked position wherein the lever portion is prohibited from moving between the two or more shift states.

9. The shift mechanism according to claim 3, further including at least one return spring that biases the rod assembly toward a locked position wherein the lever portion is prohibited from moving between the shift states.

10. The shift mechanism according to claim 1, wherein said rotatable knob is rotatably supported on said lever portion.

11. A vehicle comprising:
a shifter gate;
a lever portion movable between shift states;
an engagement mechanism that selectively allows the lever portion to move between the shift states, the engagement mechanism including a locking pin that cooperates with the shifter gate to selectively allow the lever portion to move between the two or more shift states;
a rotatable knob that cooperates with the engagement mechanism such that the engagement mechanism allows the lever portion to move between the shift states when the rotatable knob is rotated in at least a first rotational direction; and
wherein the rotation of the rotatable knob causes the locking pin to move up and down within the shifter gate.

12. The vehicle according to claim 11, wherein:
the lever portion includes a body; and
the engagement mechanism further includes a rod assembly that passes through the body.

13. The vehicle according to claim 12, wherein:
the engagement mechanism further comprises a ramped element in cooperation with the rod assembly; and
the rotatable knob includes a ramped surface that cooperates with the ramped element such that rotation of the knob presses the ramped element against the rod assembly to allow the lever portion to move between the shift states.

14. The vehicle according to claim 13, wherein the locking pin extends from the rod assembly.

15. The vehicle according to claim 14, wherein the locking pin comprises a pin extending radially away from the rod assembly in opposite directions.

16. The vehicle according to claim 13, further comprising at least one return spring that biases the ramped surface of the rotatable knob toward a locked position where the lever portion is prohibited from moving between the shift states.

17. The vehicle according to claim 13, further comprising at least one return spring that biases the rod assembly toward a locked position where the lever portion is prohibited from moving between the shift states.

18. A shift mechanism for a vehicle, comprising:
a shifter gate;
a lever portion means for moving between shift states;
an engagement mechanism means for selectively allowing the lever portion means to move between the shift states, the engagement means including a locking pin that cooperates with the shifter gate to selectively allow the lever portion to move between the two or more shift states;
a rotatable knob means for cooperating with the engagement mechanism to allow the lever portion to move between the shift states; and
wherein the rotation of the rotatable knob causes the locking pin to move within the shifter gate.

19. The shift mechanism according to claim 18, further comprising:
a rod assembly means;
a ramped surface means on the rotatable knob means; and
a ramped element means in cooperation with the rod assembly;
wherein the ramped surface means and the ramped element means are adapted to engage each other to move the rod assembly means to selectively allow the lever portion means to move between the shift states.
